(19) United States
(12) Patent Application Publication
(10) Pub. No.: US 2012/0134235 A1
(43) Pub. Date: May 31, 2012

(54) Areal Marine Seismic Exploration Method

(75) Inventors: Dmitry Anatolyevich ILINSKY, Moscow (RU); Elena Anatolyevna ILINSKY, Moscow (RU)

(73) Assignee: ZAO "GEONOD RAZVEDKA", Moscow (RU)

(21) Appl. No.: 13/304,973

(22) Filed: Nov. 28, 2011

Related U.S. Application Data
(63) Continuation of application No. PCT/RU2010/000259, filed on May 21, 2010.

(30) Foreign Application Priority Data
May 29, 2009 (RU) 2009120307

(51) Int. Cl. G01V 1/38

(52) U.S. Cl. 367/21

(57) ABSTRACT

Autonomous self-pop-up multicomponent bottom nodes (self-pop-up nodes SPN) are deployed to the bottom of an exploration area along parallel lines of exploration at specified spaced points by a recording vessel. At least one seismic source mounted on a shooting vessel continuously fires seismic energy. The shooting vessel travels between the SPN deployment lines. The direction of the sailing direction is parallel to the aforesaid lines. A source vessel is initially located at a distance from the first SPN deployment line. Every SPN records seismic waves. Upon the source vessel passes the half of the lines, the recording vessel starts on-going relocation of the deployed SPNs to the next exploration lines starting with the SPNs on the first exploration line. Collection of SPNs occurs by the recording vessel equipped with a hydro-acoustic communication system with SPNs throughout its ongoing sailing along the SPNs deployment lines. Thereafter acquired data are processed.

### RELATED APPLICATIONS

This application is a Continuation of PCT application number PCT/US2010/000259, filed on May 21, 2010, which claims priority to Russian Patent Application No. RU2009120307 filed on May 29, 2009, both of which are incorporated herein by reference in their entirety.

### FIELD OF THE INVENTION

The invention pertains to marine seismic exploration and can be used for the 3D offshore exploration of oil and gas in wide range of waters depths, in sea-land transition zones, for active and passive monitoring of offshore hydrocarbon reservoirs during its development, for sparse marine three-dimensional operations and for studying of the earth's crust.

### BACKGROUND OF THE INVENTION

Patent RU2279696 of 2006 describes and claims an offshore seismic polarization method which involves deployment of recording equipment into water, shooting, receiving and recording of seismic signals by geophone and hydrophone sensors with multifold coverage or even sounding method, registration of 3D acoustic wavefield, as well as temperature, density, salinity and water flow velocity fields, for further reconstruction of subsurface features basing on recorded delay times, synchronous shooting within 2000-5000 Hz frequency range, and determination of field circulation along closed ray trajectories by comparison of direct readings of mutually opposite rays time differences in the loop, reconstruction of sound velocity field, basing on deep-sea raypath time differences for determination of relative positions of recording sensors.

The weakness of the above method is the low reliability and accuracy of offshore exploration, given its inability to obtain the image of a sedimentary layer at the required depth because of high frequency of acoustic signal that travels only within near-bottom layers.

Patent RU2246122 of 2005, describes and claims the closest to the technical principles of the proposed invention method, namely the offshore multiwave multicomponent seismic acquisition method, which involves the synergy of cumulative synchronous measurements of autonomous ocean bottom seismic stations, deployed within the pre-defined area, with near- and far-offset towed seismic streamers used as a source, for obtaining of kinematic and dynamic characteristics from recorded refracted, reflected, head P- and S-waves that were synchronously registered by autonomous bottom seismic stations from near- and far-offset seismic streamers.

The weak point of this method is a low reliability and accuracy of offshore exploration, given two-dimensional type of seismic profiling carried out in certain directions defined by the towed streamer route, as well as offset limitation determined by the streamer length, and low performance of the method, which is explained by the presence of two different receivers types, provided that one of these (streamer) does not work during deployment and recovery of autonomous bottom seismic stations from the sea floor. In addition, reliable sparse multicomponent bottom measurements cannot provide reliable subsurface image of horizontal and vertical components, besides, streamer and sea-bottom data merge can be encumbered by the waveform and signal frequency differences.

### SUMMARY OF THE INVENTION

The technical advantage of the invention is the enhanced reliability and accuracy of marine three-dimensional seismic exploration as a result of full-azimuth illumination of a target zone, increased performance of the survey, acquisition costs reduction and improved quality of the results.

The above technical benefits are achieved through application of three-dimensional marine seismic exploration method, which involves the deployment of autonomous self-pop-up multicomponent bottom nodes (self-pop-up nodes SPN) along parallel lines of exploration at specified spaced points by a recording vessel, repeated continuous firing of seismic energy by at least one seismic source mounted on the shooting vessel sailing between the lines of SPNs deployment, with the shooting vessel sailing direction parallel to the said lines, recording of seismic signals by each SPN; processing of acquired data, which involves extraction of primary reflections from the recorded signals with suppression of multiples through summation of vertical component of displacement velocity in the sea bottom with pressure recordings in water layer, with generation of three-dimensional time and depth seismic images from acquired data; furthermore, after a source vessel travels through the half of lines, the ongoing relocation of the deployed SPNs to the next exploration lines starts with the SPNs deployed on the first exploration line; the recovery of SPNs is carried out by the recording vessel equipped with a hydro-acoustic communication system with SPNs throughout its ongoing sailing along the lines of exploration (FIG. 1 (1)), and the source vessel is initially located at an R distance from the first exploration line that can be defined as follows: 0.5D≦R≦D, where D is the exploration area width.

The distinctive features of the invention includes: deployment of autonomous self-pop-up multicomponent bottom nodes (self-pop-up nodes SPN) along parallel lines of exploration at specified spaced points by a recording vessel, repeated continuous firing of seismic energy by at least one seismic source installed on a shooting vessel sailing between the lines of exploration with deployed SPNs, with the shooting vessel sailing direction parallel to the said lines, recording seismic signals by each SPN; processing of acquired data, involving primary reflections extraction from the recorded signals with multiples suppression through summation of vertical component of displacement velocity in the sea bottom with pressure recordings in a water layer, with generation from acquired data of three-dimensional time and depth seismic images of the study area; furthermore, after a source vessel travels through a half of all exploration lines, the on-going relocation of the deployed SPNs to the next exploration lines starts with the first exploration line; the recovery of SPNs is carried out by the recording vessel equipped with a hydro-acoustic communication system with SPNs throughout its ongoing sailing along the lines of exploration, and the source vessel is initially located at an R distance from the first exploration line that can be defined as follows: 0.5D≦R≦D, where D is the exploration area width. This provides increased reliability and accuracy of marine seismic exploration. The deployment of autonomous self-pop-up multicomponent bottom nodes (self-pop-up nodes SPN) along parallel lines of exploration at specified spaced points by a recording vessel provides reliability and accuracy of seismic exploration through full azimuth (covering all directions) investigations of target structures of an exploration area, which provides full azimuth amplitude distribution maps of target structures of an exploration area for identification and orientation of fault planes as a result of gaining of required distance of an energy source from SPNs in all directions, which provides subsalt and thrust zones images in complex geological environments due to: elimination of swell noise impact to exploration results; and due to full data coverage without acquisition gaps in shallow waters or in areas with obstacles, or heavy vessel traffic and intense fishing activities areas; and due to frequency extension of recorded at sea bottom signals, which provides images of more deep structures. The autonomy of SPNs allows full-azimuth wide-angle offshore seismic acquisition with constant quality control of every SPN recovered records and repeated data recording when needed. The multicomponent design of SPNs allows shear-wave imaging of target structures, remove water-borne multiple contamination of final image. The self-pop-up feature of SPNs allows high performance of offshore seismic survey. Deployment of SPNs along parallel lines of exploration at specified spaced points provides uniform distribution and spacing resulting in uniform data coverage. Processing of acquired data, involving primary reflections extraction from the recorded signals with multiples suppression through summation of vertical component of displacement velocity in the sea bottom, with pressure recordings in a water layer, with generation of quality P- and S-waves image of target structure of exploration area. The on-going relocation of the deployed SPNs to the next exploration lines from the first line, after a source vessel passed half of all exploration lines makes it possible to use least possible number of SPNs and provide nonstop shooting by a source vessel, which essentially decrease survey time, therefore reduce survey costs. The recovery of SPNs is carried out by the recording vessel equipped with a hydro-acoustic communication system with SPNs throughout its ongoing sailing along the lines of exploration, which provides increased survey efficiency. Since the SPNs are positioned on parallel lines of exploration, and the source vessel sails along these lines. The initial location of a source vessel at an R distance from the first exploration line defined as 0.5D≦R≦D, where D is the exploration area width, provides uniform survey fold, uniform azimuth distribution of near and far offsets, that increase reliability and accuracy of exploration.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic illustration of SPNs location during first deployment at the seafloor and initial position of a source vessel;

FIG. 2 is a schematic illustration of movement of a recording vessel

FIG. 3 is a schematic illustration of recovery of SPNs of a recording vessel; and

FIG. 4 is a schematic illustration of a fragment of arrangement with the two profiles shown SPN and the trajectory of the shooting vessel with a double-emitter source.

### DETAILED DESCRIPTION OF THE PREFERRED EMBODIMENTS

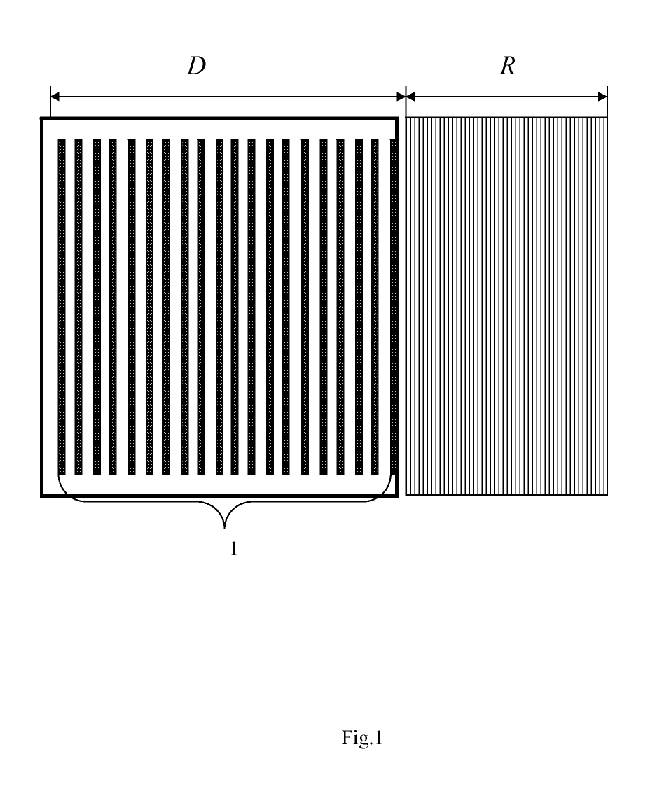

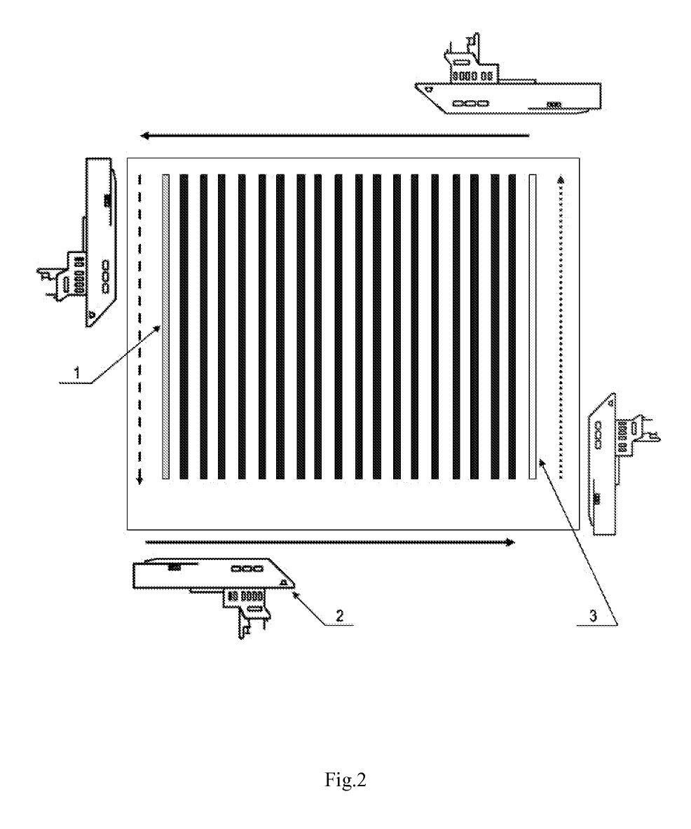

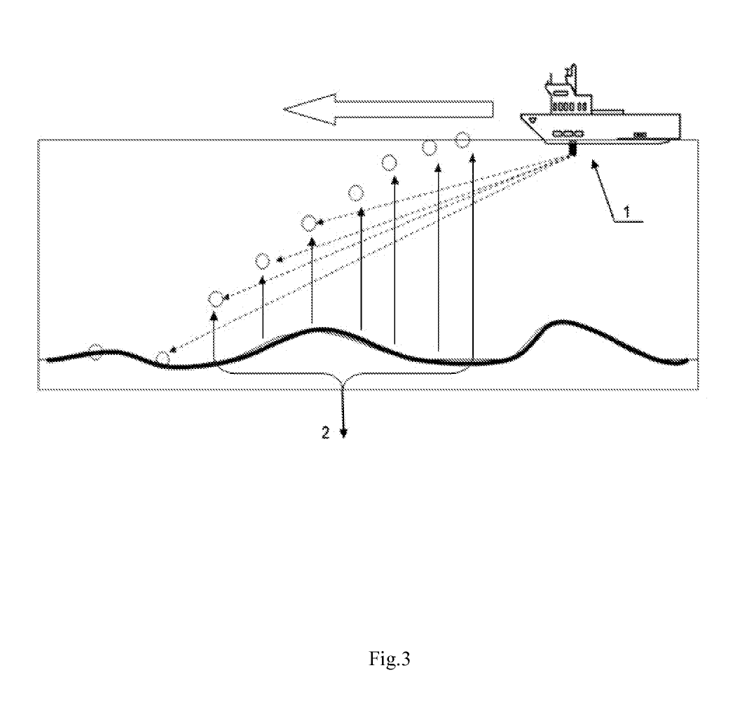

The method of three-dimensional marine seismic exploration can be explained by the drawing in FIG. 1, which illustrates SPNs location during first deployment at the seafloor and initial position of a source vessel, in FIG. 2—movement of a recording vessel, and in FIG. 3—recovery of SPNs of a recording vessel.

The method of three-dimensional marine seismic exploration is implemented in the following way. Autonomous self-pop-up multicomponent bottom nodes (SPNs) are deployed along parallel lines of exploration at specified spaced points by a recording vessel. The specified spaced points of the deployment of SPN, i.e. projected distance on the bottom, distance between recorders along the lines of their placement and their placement between the lines as a function of depth and resolution from images of the medium. It can range from tens of meters to several kilometers (FIG. 2, where 1 is the deployment of SPN to the new line, 2—recording vessel, 3—collection of SPNs from the completed line).

At least one seismic source mounted on a shooting vessel sails between the lines of exploration with deployed SPNs continuously firing seismic energy. A source vessel moves between the lines with deployed SPNs. The vessel sailing direction is parallel to the exploration lines. At the start of operations the source vessel is located at R distance from the first exploration line, defined as 0.5D≦R≦D, where D is the exploration area width. Every SPN registers seismic responses. After passing through the half of the exploration lines the continuous relocation of the SPNs to the subsequent lines launches, starting from the SPNs positioned the first line.

After a source vessel passes through the half of exploration lines, the on-going relocation of SPNs to the following exploration lines starting from SPNs located on the first line. This method of deployment of the bottom nodes maintains uniform folding of recording, not only in the longitudinal and transverse direction.

The recovery of SPNs is carried out the recording vessel equipped with a hydro-acoustic communication system, during its ongoing sailing along the lines of exploration with deployed SPNs. Upon recorded data is downloaded from the SPNs, it must be processed, which includes identification in the registered signals of primary and multiple waves by means of summation of the vertical component of bottom particle velocity and water pressure, generation of three-dimensional depth and time images of the study area.

The implementation of three-dimensional marine seismic exploration method described as specific case study is following.

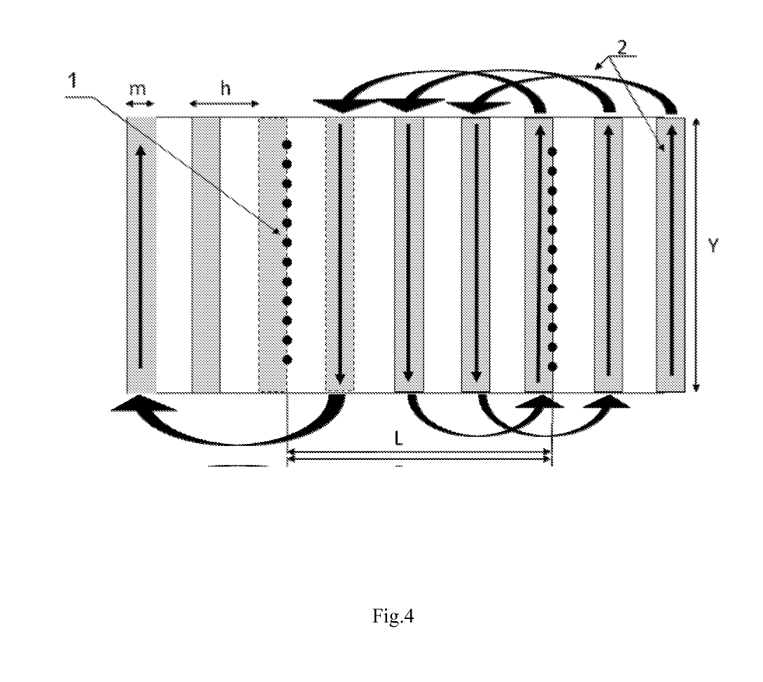

FIG. 4 represents a fragment of arrangement with the two profiles shown SPN and the trajectory of the shooting vessel with a double-emitter source.

In the study area covering 360 km² (20 km×18 km) work two vessels, specifically a recording vessel and a source vessel. 496 autonomous self pop-up multicomponent bottom recorders (SPNs) are deployed to the bottom of 20 km×5 km section, along 12 exploration lines at specified spaced points. 41 SPN are deployed every 450 m to each line of exploration. A source vessel tows two sources featuring two serially attached pneumatic airguns of different volume arranged at least in two rows and alternatively firing seismic energy. A source vessel travels between the SPNs deployment lines. The movement direction of a source vessel is in parallel to the aforesaid lines. FIG. 4 (1—lines of SPN, 2—trajectory of the source vessel; L-distance between two adjacent lines of SPN, m=50 m—distance between the two sources, towed behind source vessel, h=100 m—sources coverage width of the area during a single pass of source vessel, Y=18 km—length of the line)

A source vessel starts shooting at R distance from the first SPN deployment line, which is calculated as 2.5 km calculated as 0.5D≦R≦D where D is a width of the section where the SPNs are deployed. R=2.5; D=5 km. The deployment of SPNs is carried out during the source vessel shooting. It is equipped with high-performance compressors, high pressure switchboard connecting compressors to each airgun, a reasonably capacious compressed air receiver, high pressure pipes supplying compressed air to each airgun, water resistant electric cable feeding back firing signal to each airgun from a computer airgun controller and transmitting response signals from each airgun back to the computer airgun controller, navigation system computing the time of every airgun shot corresponding to the current vessel position and pre-planned survey layout.

The distance between the airguns is 1.5-2 meters and is selected with regard to the needed required wavelet signature of each airgun. Prior to shooting the airguns are deployed astern and positioned at opposite boardsides in order their trajectories do not cross over. The compressors provide shooting system with compressed air. During shooting the navigation system sends a firing impulse to the computer airgun controller and a firing signal to each airgun. The shot time of each airgun is transmitted back to the controller for planning of a specific delay for the next shot for each airgun in order to provide the best possible synchronism of the whole airgun array. At the other moment, when another airgun array approaches predetermined shotpoint, the navigation system send the firing signal.

The process repeats until the whole section is completed. The recording vessel has the front deck housing and the big aft desk where the sufficient number of SPNs and ballast weights thereof can be placed. The hydrophones of acoustic transducers are firmly attached to the vessel hull for hydroacoustic connection with SPN. This can be done either through the moon pull in the hull, or it can be fastened to the shipside on the outboard pivoted arm. A grabbing basket and a transportation belt are used for the pick-up of the floating SPNs from the water surface for the delivery of SPNs to the deck.

After the shooting vessel passed the half of the exploration lines the ongoing relocation of the deployed SPNs to the next exploration lines starts with the SPNs located on the first exploration line. The recovery of SPNs is carried out by the recording vessel equipped with a hydro-acoustic communication system with SPNs throughout its ongoing sailing along the lines of exploration. Then acquired SPNs data is downloaded and processed, which involves extraction of primary reflections with suppression of multiples through summation of vertical component of displacement velocity in the sea bottom, with pressure recordings in a water layer, generation from acquired data of three-dimensional time and depth seismic images of the study area. The quality control and pre-processing of acquired data, as well as SPNs checking and programming is provided by the PC connected to the wireless access point on the desk. A satellite marine navigation system is used for the vessel positioning. Before deployment, the data recording parameters of SPN are assigned (number of channels, sample rate, start recording time etc.), then, after attaching a ballast weight thereto it is placed on the transportation belt that delivers the instrument to the sea level (a skew surface of stern is typically used), once SPN comes to the deployment position the navigation system sends release signal to the deployment system and it releases the SPN. The SPN goes down into water and sinks to the recording position. During SPNs recovery the recording vessel arrives to the start point of the SPN exploration line. Every SPN is supplied by its unique identification code for hydroacoustic connection with the vessel (via hydroacoustic antenna). The recording vessel sends repeatedly hydroacoustic release signals to every deployed SPN with little time delay and sails up to the floating upwards SPNs. Upon receiving a release signal, a submerged SPN gets rid of the ballast weight and rises to the sea surface. The ascend time depends on the sea depth, at a constant velocity calculated as F_{arch}−mg)/(C ρ_{w} S)}^{0.5} where (F_{arch}−mg) is—resulting buoyant force equal to the difference of Archimedes force and weight in air, ρ_{w}—water density in kg/m³, S-sectional area of the SPN housing in m² and C—non-dimensional coefficient depending on the SPN housing sectional area shape, which is equals to 1 for a sphere. The recording vessel starts collecting ascended SPNs simultaneously sending release signals to the successive SPNs positioned on the exploration line, in the manner to provide nonstop sailing along SPN line with recovery of SPNs as soon as they come up to the water surface. The recording vessel can be supplied with the special grabbing basket and a transportation belt for SPNs pick-up from the water surface. This equipment provides more efficient pick-up of floating SPNs and fast delivery thereof onboard the vessel. Upon delivery on the vessel desk, recorded data is downloaded from the SPN to the PC via wireless of wired network, then the SPN is programmed for the next recording cycle and upon attaching a new ballast weight, it is prepared for the next deployment.

The proposed method of three-dimensional marine seismic exploration provides increased reliability and accuracy of marine three-dimensional seismic exploration as a result of full-azimuth illumination of a target zone, improved performance of the survey, reduced acquisition costs with improved quality of the results.

Application: offshore seismic exploration, three-dimensional offshore exploration of oil and gas with wide range of depths, in sea-land transit zones, active and passive monitoring of offshore hydrocarbon reservoirs during its development, offshore sparse three-dimensional surveys, for studying of the earth's crust.

While this invention has been particularly shown and described with references to preferred embodiments thereof, it will be understood by those skilled in the art that various changes in form and details may be made therein without departing from the scope of the invention encompassed by the appended claims.

What is claimed is:

1. Three-dimensional marine seismic exploration method involving a deployment of autonomous self-pop-up multicomponent bottom nodes (self-pop-up nodes SPN) along parallel lines of exploration at specified spaced points by a recording vessel, repeated continuous firing of seismic energy by at least one seismic source installed on a shooting vessel sailing between the lines of exploration with deployed SPNs, with the shooting vessel sailing direction parallel to the said lines, recording seismic signals by each SPN; processing of acquired data, involving primary reflections extraction from the recorded signals with multiples suppression through summation of vertical component of displacement velocity in the sea bottom with pressure recordings in a water layer, with generation from acquired data of three-dimensional time and depth seismic images of the study area, furthermore, after a source vessel travels through a half of all exploration lines, the on-going relocation of the deployed SPNs to the next exploration lines starts with the first exploration line, and the recovery of SPNs is carried out by the recording vessel equipped with a hydro-acoustic communication system with SPNs throughout its ongoing sailing along the lines of exploration.

2. The method according to claim 1 wherein the source vessel is positioned at R distance from the first SPNs line, equals to 0.5D≦R≦D, where D−width of exploration area.
